(19) United States
(12) Patent Application Publication
(10) Pub. No.: US 2003/0161905 A1
(43) Pub. Date: Aug. 28, 2003

(54) Blow molding mold assembly with a dyeing device

(76) Inventors: Jui-Peng Hsieh, Taichung City (TW); Chi-Cheng Fu, Su-Lin (TW); Chien Min Hsiao, Taipei City (TW)

Correspondence Address: CHARLES E. BAXLEY, ESQUIRE, Hart, Baxley, Daniels & Holton, 59 John St, 5 Fl, New York, NY, 10038, US

(21) Appl. No.: 09/812,384

(22) Filed: Mar. 21, 2001

(51) Int. Cl. B29C 45/16

(52) U.S. Cl. 425/130; 425/375

(57) ABSTRACT

A blow molding mold assembly includes a first mold having a recess for receiving a dye permeable member therein. A second mold is overlapped on the first mold and a mediate mold is clamped between the first mold and the second mold. A connection pipe assembly extends through the first mold and communicates with the dye permeable member so as to let dye attached on the material located on the mediate mold via the dye permeable member.

### FIELD OF THE INVENTION

The present invention relates to a blow molding mold assembly that has a dyeing device allowing the product made from the mold assembly to have desired colored pattern simultaneously.

### BACKGROUND OF THE INVENTION

A conventional product made by way of blow molding generally includes a single plastic layer and some patterns are formed on the product. In order to have a better esthetic feature that attracts consumers' attention, the patterns are colored by manual after the product is made. The colors on the patterns cannot last long and are easily worn out. An improved way to achieve the purpose is to make two layers one of which has an aperture and the other layer has colored patterns The colored patterns have tapered outer periphery so as to be engaged with the periphery of the aperture. In other words, the two layers are overlapped and the colored patterns are shown in the aperture Although both of the layers are made by way of blow molding, the manufacturers have to prepare two different molds and the two layers are assembled by manual way. The two layers are made by different material having ingredients so that they have different shrink rate and the size of the aperture could not meet the size of the colored patterns.

The present invention intends to provide a mold assembly, that allows the dyeing process to be completed when molding the product.

### SUMMARY OF THE INVENTION

In accordance with one aspect of the present invention, there is provided a blow molding mold assembly and including a first mold having a recess for receiving a dye permeable member therein and a second mold is overlapped on the first mold with a mediate mold is clamped between the first mold and the second mold. Material is injected between the mediate mold and the second mold and dye is attached on the material via the dye permeable member.

The primary object of the present invention is to provide a blow molding mold assembly wherein the product can be colored during the molding process.

These and further objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is a perspective view to show the blow molding mold assembly of the present invention;

FIG. 2 is an exploded view to show the blow molding mold assembly of the present invention;

FIG. 3 is a cross sectional view to show a layer of material is injected between the second mold and the mediate mold of the blow molding mold assembly of the present invention, and

FIG. 4 is a cross sectional view to show the second mold is separated from the layer of material and dye is attached on the layer of the material.

### DETAILED DESCRIPTION OF THE PREFERRED EMBODIMENT

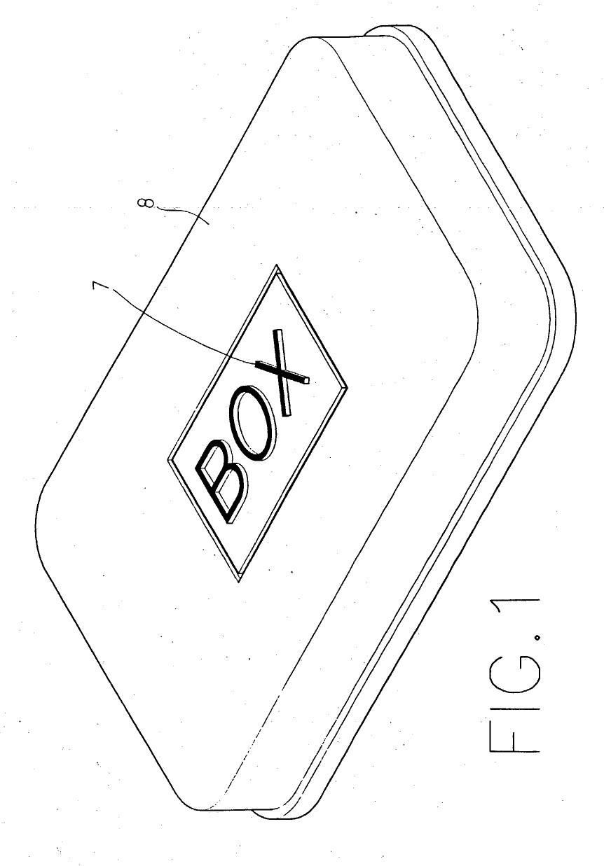

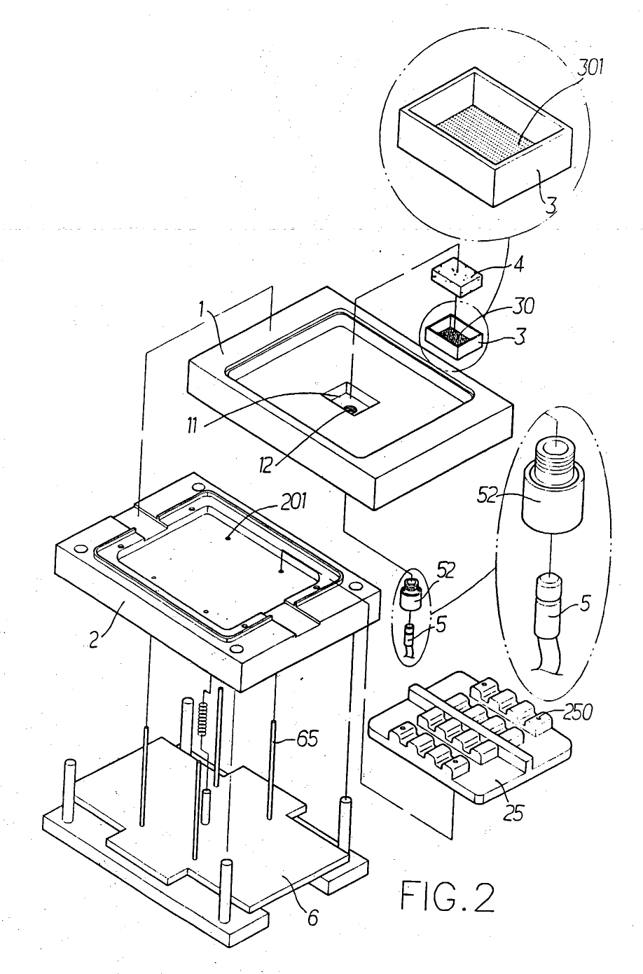

Referring to FIGS. 1 to 3, the blow molding mold assembly of the present invention comprises a first mold 1 having a recess 11 defined in a surface thereof so as to receive a dye permeable member therein. The dye permeable member includes a frame 3 having a netted bottom 30 and a sponge member 4 which is received in the frame 3. The netted bottom 30 includes tiny holes 301 which diameters are less than 1.5 mm. A pipe assembly extends through the first mold 1 and communicates with the sponge 4 so that oily dye is absorbed by the sponge member 4 via the pipe assembly. The pipe assembly in this embodiment includes a fitting 52 threadedly connected to the first mold 1 and a hose 5 is engaged with the fitting 52.

A second mold 2 is overlapped on the first mold 1 and a mediate mold 25 is clamped between the first mold 1 and the second mold 2. The mediate mold 25 has patterns defined thereon.

A movable plate 6 is engaged with the second mold 2 and has position pins 65 extending therefrom. The position pins 65 extend through holes 201 in the second mold 2, holes 250 in the mediate mold 25, and connected to the first mold 1 to connect the three molds 1, 2, 25 together.

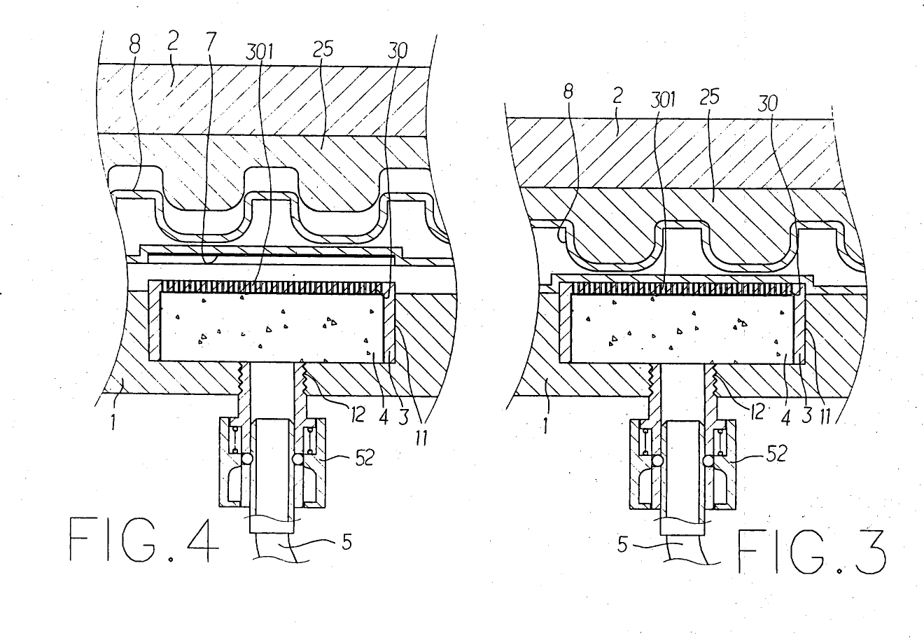

A layer of material 8 is injected between the space between the second mold 2 and the mediate mold 25 so as to formed as the patterns on the mediate mold 25 and the dye is permeable through the holes 301 in the netted member 30 of the frame 3 and attached on the material 8. The dye 8 is quickly dry and securely attached on the material 8. As shown in FIG. 4, when removing the second mold, 2 away from the mediate mold 25 and the first mold 1, the product as shown in FIG. 1 is completed with colored patterns 7 on it. By the mold assembly, the product can be done and the colored patterns 7 are completed within one molding process.

While we have shown and described various embodiments in accordance with the present invention, it should be clear to those skilled in the art that further embodiments may be made without departing from the scope and spirit of the present invention.

What is claimed is:

1. A blow molding mold assembly comprising:
a first mold, a dye permeable member connected to said first mold;
a second mold overlapped on said first mold, and
a movable plate engaged with said second mold and having position pins extending therefrom, said position pins extending through said second mold and said first mold.

2. The assembly as claimed in claim 1 further comprising a recess defined in a surface of said first mold and said dye permeable member engaged with said recess.

3. The assembly as claimed in claim 1 further comprising a mediate mold clamped between said first mold 1 and said second mold, said mediate mold facing said dye permeable member.

4. The assembly as claimed in claim 1, wherein said dye permeable member includes a frame having a netted bottom and a sponge member is received in said frame, a pipe assembly extending through said first mold and communicating with said sponge.

5. The assembly as claimed in claim 4, wherein said pipe assembly includes a fitting threadedly connected to said first mold and a hose engaged with said fitting.

6. The assembly as claimed in claim 1 wherein said netted bottom includes tiny holes which diameters are less than 1.5 mm.
